(19) United States
(12) Patent Application Publication
(10) Pub. No.: US 2012/0188198 A1
(43) Pub. Date: Jul. 26, 2012

(54) INPUT METHOD AND APPARATUS FOR CAPACITIVE TOUCH SCREEN TERMINAL

(75) Inventors: Yong-Soo JEONG, Gyeonggi-do (KR); Soo-Hyun PARK, Seoul (KR); Jin PARK, Gyeonggi-do (KR); Min-Ji KIM, Seoul (KR)

(73) Assignee: SAMSUNG ELECTRONICS CO., LTD., Gyeonggi-Do (KR)

(21) Appl. No.: 13/353,739

(22) Filed: Jan. 19, 2012

(30) Foreign Application Priority Data
Jan. 21, 2011 (KR) 10-2011-0006154

(51) Int. Cl. G06F 3/044

(52) U.S. Cl. 345/174

(57) ABSTRACT

An input method and apparatus for implementing a non-contact touch sensing method according to a corresponding function in a capacitive touch screen terminal. The sensed capacitance varies as a finger or special pointer approaches the surface of the touchscreen without making actual contact, and different thresholds of capacitance can be used to trigger different functions. The method preferably includes sensing a request of a corresponding function, verifying whether or not the requested corresponding function is performed by a non-contact touch sensing method, and implementing a non-contact touch sensing region set for the corresponding function when the corresponding function is performed by the non-contact touch sensing method.

### CLAIM OF PRIORITY

This application claims the benefit under 35 U.S.C. §119(a) from a Korean patent application filed in the Korean Intellectual Property Office on Jan. 21, 2011 and assigned Serial No. 10-2011-0006154, the entire disclosure of which is hereby incorporated by reference in its entirety.

### BACKGROUND OF THE INVENTION

1. Field of the Invention

The present invention relates to a capacitive touch screen terminal. More particularly, the present invention relates to an input method and apparatus for implementing a non-contact touch sensing method according to a corresponding function in a capacitive touch screen terminal.

2. Description of the Related Art

Portable terminals, such as mobile terminals, electronic schedulers, and personal complex terminals, particularly with wireless transceiving capability have become necessities of modern life as advances in the electronic communication industry has made it possible to include a varied amount of functionality in a relatively small device with considerable processing power. The portable terminals have developed into important means of information transmission, which continues to change at a rapid pace.

Touch screen technology is being applied to many portable terminals, and this feature has increased the popularity of these devices, and helped to decrease the thickness of such devices. If a user is in contact with the touch screen, an input can be induced. An input device is mounted in the touch screen. If the input device is touched by fingers of the user or a stylus, it is input with information about the touched position. Accordingly, the touch screen satisfies the user due to its convenience.

An example of such touch screens includes a capacitive touch screen, a resistive touch screen, a surface wave touch screen and an Infrared touch screen. The capacitive touch screen has an advantage over the other types of touch screens in that when in operation the feeling and scrolling of the touch screen are both smooth and multi-touch may be performed. Therefore, the capacitive touch screen is widely used in comparison with a different-type touch screen.

In the capacitive touch screen in particular, a screen surface is charged, and sensors are installed around the screen surface to monitor the capacitive at certain positions of the screen. The capacitive touch screen senses conductive charges changing (typically being reduced) when a conductor such as a finger of the user is touched and ascertains the touched region. Stated another way, the capacitive touch screen recognizes that an input signal is output at the same time that the finger of the user is in contact with the screen surface. However, this type of input method according to screen contact may have a problem. First, finger marks often remain on the screen surface result in a continuously degraded readability when the user reads photos, moving pictures, etc. Also, the finger marks result in leakage risk of personal information.

For example, when the marks left on the screen are fingerprints of the user, which may remain on the screen surface for a significant period of time, may be used for leaking personal information and be abused by a third party. For another example, some portable terminals provide a pattern locking/unlocking method. In the pattern locking/unlocking method, a pattern connected when the user touches and moves points selected from among 9 points displayed on the portable terminal in order is set to a password. If the user touches and moves the points later using the predetermined pattern, the password is released. This pattern locking/unlocking method is safer in security than a conventional four-digit password method. However, the pattern may be detected due to finger marks which remain on the screen surface after use.

### SUMMARY OF THE INVENTION

An exemplary aspect of the present invention is to solve at least some of the above-mentioned problems and/or disadvantages and to provide at least some of the advantages described below. Accordingly, an exemplary aspect of the present invention is to provide an input method and apparatus for implementing a non-contact touch sensing method according to a corresponding function in a capacitive touch screen terminal.

Another exemplary aspect of the present invention is to provide an input method and apparatus for outputting a plurality of signals according to distance adjacent to a corresponding touch region in a capacitive touch screen terminal.

Another exemplary aspect of the present invention is to provide an input method and apparatus for recognizing a user's touch of a touchscreen by a non-contact touch sensing method and protecting his/her personal information because fingerprints or finger marks do not remain on a screen.

Another exemplary aspect of the present invention is to provide an input method and apparatus for enhancing readability by recognizing a user's touch of a touchscreen by a non-contact touch sensing method and cleanly maintaining a screen in a capacitive touch screen terminal.

An input method in a capacitive touch screen terminal preferably comprises: detecting by a controller whether a request of a corresponding function is made; verifying by the controller whether or not the requested corresponding function is to be executed by a non-contact touch sensing method on a touch screen; and configuring a display of a non-contact touch sensing region of the touch screen set for executing the corresponding function in which the corresponding function is to be executed by performing the non-contact touch sensing method by sensing a specific pattern of finger or pointer approaching a surface of the non-contact touch sensing region of the touch screen so as to trigger at least one threshold sensed by a sensor.

In accordance with an exemplary embodiment of the present invention, an input method in a capacitive touch screen terminal is provided. The input method preferably includes sensing a request of a corresponding function, verifying whether the requested corresponding function is performed by a non-contact touch sensing method, and implementing a non-contact touch sensing region set for the corresponding function when the corresponding function is performed by the non-contact touch sensing method.

In accordance with another exemplary embodiment of the present invention, an input method in a capacitive touch screen terminal is provided. The input method preferably includes verifying the variable capacitance of a corresponding touch region, and recognizing that a first signal is output when the variable capacitance reaches a first threshold capacitance and recognizing that a second signal is output when the variable capacitance reaches a second threshold capacitance. The second threshold capacitance is higher than the first threshold capacitance.

Other exemplary aspects, advantages and salient features of the invention will become more apparent to a person of ordinary skill in the art from the following detailed description, which, taken in conjunction with the annexed drawings, discloses exemplary embodiments of the invention in more detail.

### BRIEF DESCRIPTION OF THE DRAWINGS

The above and other exemplary aspects and advantages of certain exemplary embodiments of the present invention will become more apparent to the person of ordinary skill in the art from the following detailed description taken in conjunction with the accompanying drawings, in which:

FIG. 1 is a block diagram of a capacitive touch screen terminal according to an exemplary embodiment of the present invention;

FIG. 2A illustrates a non-contact touch sensing method in a capacitive touch screen terminal according to an exemplary embodiment of the present invention;

FIG. 2B is a flowchart illustrating exemplary operation of a touch recognition process in a capacitive touch screen terminal according to an exemplary embodiment of the present invention;

FIG. 3 is a flowchart illustrating exemplary operation of a process of determining whether a corresponding function is performed by a non-contact touch sensing method in a capacitive touch screen terminal according to an exemplary embodiment of the present invention;

FIG. 4A to FIG. 4C illustrate exemplary screen shots for displaying a corresponding function performed by a non-contact touch sensing method in a capacitive touch screen terminal according to an exemplary embodiment of the present invention;

FIGS. 5A-5C illustrate a process of outputting a plurality of signals according to distance in which a conductor is adjacent to a corresponding touch region in a capacitive touch screen terminal according to an exemplary embodiment of the present invention; and

FIG. 6A is a flowchart illustrating a process of recognizing that a plurality of signals are output according to distance in which a conductor is adjacent to a corresponding touch region in a capacitive touch screen terminal according to an exemplary embodiment of the present invention.

FIG. 6B is a flowchart providing a loop that continues from and may go back to the process of FIG. 6A.

### DETAILED DESCRIPTION

Exemplary embodiments of the present invention will be described herein below with reference to the accompanying drawings. In the following description, well-known functions or constructions may not be described in detail when their inclusion would obscure the invention with unnecessary detail of well-known functions or constructions. Also, the terms used herein are defined according to the functions of the present invention. Thus, the terms may vary depending on user's or operator's intension and usage. That is, the terms used herein must be understood based on the descriptions made herein.

The present invention described hereinafter relates to a touch screen terminal. More particularly, the present invention relates to an input method and apparatus for implementing a non-contact touch sensing method according to a corresponding function. In addition, the present invention relates to an input method and apparatus that outputs a plurality of signals according to distance adjacent to a corresponding touch region in a capacitive touch screen terminal according to an exemplary embodiment of the present invention.

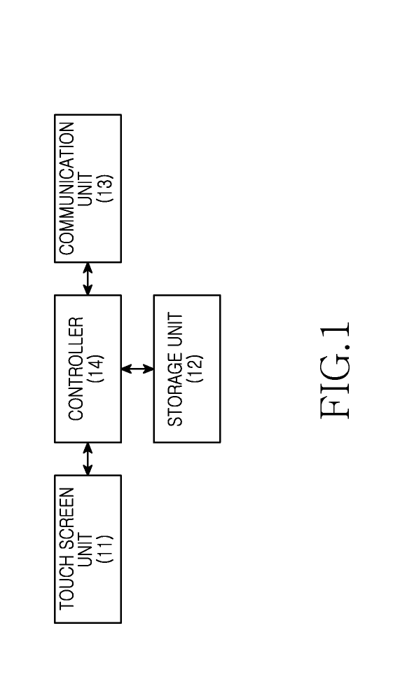

FIG. 1 is a block diagram of a capacitive touch screen terminal according to an exemplary embodiment of the present invention.

Referring now to FIG. 1, the touch screen terminal according to an exemplary embodiment of the present invention preferably includes a touch screen unit 11 for input and output, a storage unit 12 for storing data, a communication unit 13 for performing communication, and a controller 14 for controlling an overall operation.

The touch screen unit 11 outputs to the controller 14 an input signal according to a touch of a user, and receives and displays a display signal in accordance with control of the controller 14. In this particular exemplary embodiment of the present invention, a capacitive touch screen is employed as the touch screen unit 11. As discussed hereinafter, the controller 14 verifies a level of variable capacitance which is varied at a touch region of the capacitive touch screen, and recognizes that an input signal is generated at a touch point (or touch region) where the variable capacitance reaches a predetermined threshold level of capacitance.

The storage unit 12, which preferably comprises a non-transitory machine readable medium, stores a certain program for controlling an overall operation of the touch screen terminal and a variety of data input and output when a control operation of the touch screen terminal is performed. As discussed hereinafter, the storage unit 12 stores information about a non-contact touch sensing method.

The communication unit 13 performs wire or wireless communication under control of the controller 14.

The controller 14, which is preferably a processor or microprocessor, controls an overall operation of the capacitive touch screen terminal. Hereinafter, an input method according to an exemplary embodiment of the present invention in the controller 14 will now be described in detail with reference to the drawings.

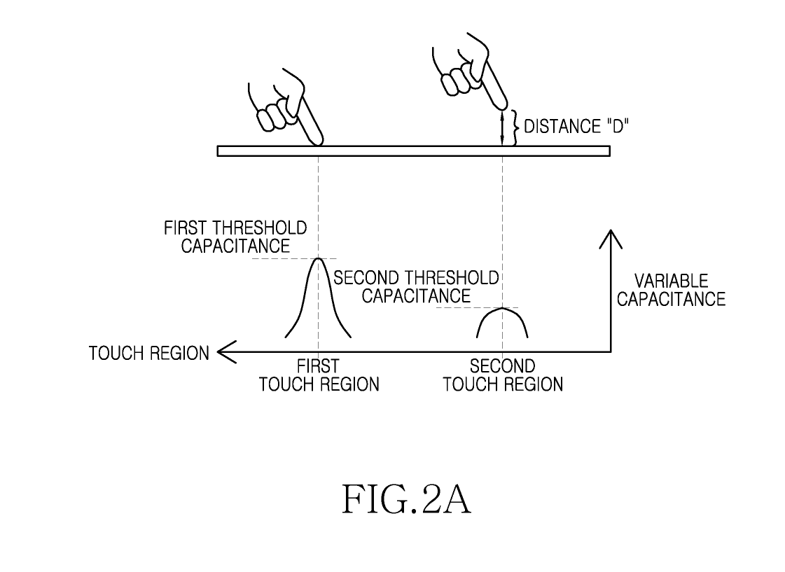

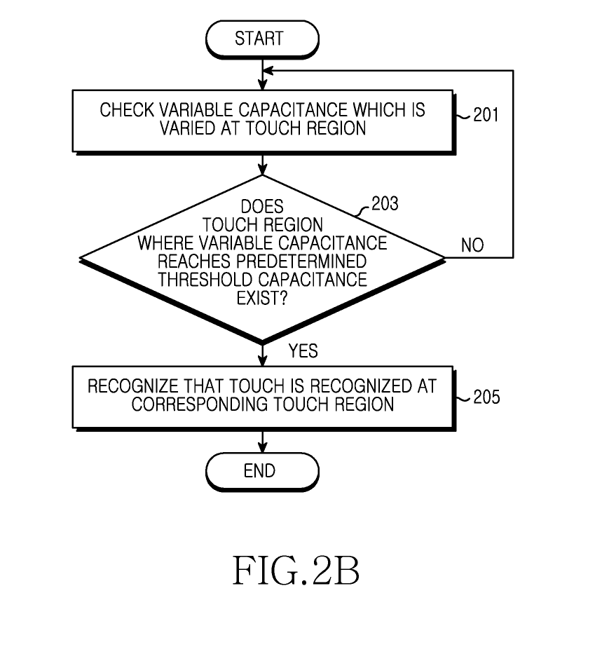

FIG. 2A illustrates a non-contact touch sensing method in a capacitive touch screen terminal according to an exemplary embodiment of the present invention.

Referring now to FIG. 2A, the controller 14 preferably configures a touch region as a touch recognition region and a non-contact touch sensing 15 region. The touch recognition region is a region where a conductor must be in contact with a screen and a signal is output. The non-contact touch sensing region is a region where a signal is output although the conductor is not in contact with the screen but away at a distance “D” sufficient to change the capacitance to the second threshold. Accordingly, a touch of the conductor may be recognized at a long distance in comparison with a different touch region. The non-contact touch sensing region means that touch sensitivity is relatively high.

If a conductor such as a user's finger approaches the capacitive touch screen, capacitance of a corresponding touch region changes. The controller 14 checks variable capacitance which is varied throughout touch regions, and recognizes that a signal is generated only if the variable capacitance reaches a predetermined threshold value (threshold capacitance).

Accordingly, in order to implement a non-contact touch sensing region, the controller 14 sets the threshold capacitance at a corresponding region to be lower than that at a touch recognition region. That is, because the variable capacitance reaches the predetermined threshold capacitance level although a finger of the user does not come in contact with the non-contact touch sensing region, yet a signal is still output. The output signal may be valid or invalid. For example, a signal generated from a button that displays information about a corresponding function is valid.

FIG. 2B is a flowchart illustrating a touch recognition process in a capacitive touch screen terminal according to an exemplary embodiment of the present invention.

Referring now to FIG. 2B, at step (2)1 the controller 14 checks variable capacitance which is varied at a touch region.

Next, at step (203), the controller 14 verifies whether or not a touch region where the variable capacitance reaches a threshold capacitance exists.

When the touch region where the variable capacitance reaches the threshold capacitance exists, the controller 14 at step (205) verifies that touch is recognized at the touch region. As described above, the threshold capacitance may be differently set according to different touch regions.

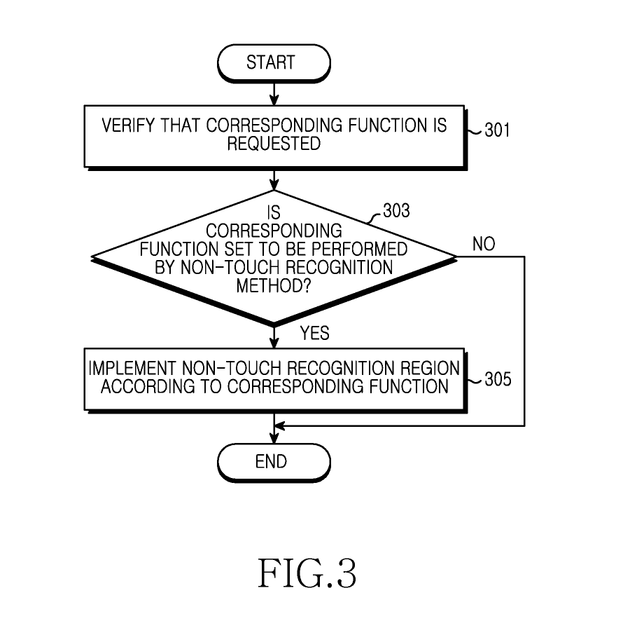

FIG. 3 is a flowchart illustrating an exemplary process of determining whether a corresponding function is performed by a non-contact touch sensing method in a capacitive touch screen terminal according to an exemplary embodiment of the present invention.

Referring now to FIG. 3, at step (301) the controller 14 verifies that the corresponding function is requested.

At step (303), the controller 14 verifies whether the requested corresponding function is set to be performed by the non-contact touch sensing method.

If the corresponding function is set to be performed by the non-contact touch sensing method, as described in FIG. 2A and FIG. 2B, then at step (305) the controller 14 implements a non-contact touch sensing region.

Herein, the function performed by the non-contact touch sensing method may be a function with leakage risk of personal information such as entering a password. Also, the function performed by the non-contact touch sensing method may be a moving picture function, a photo function, etc. in which readability becomes poor if finger marks remain on a screen.

The function performed by the non-contact touch sensing method may be designated by those skilled in the art, and/or may be designated by environment setup of a user or a changeable default.

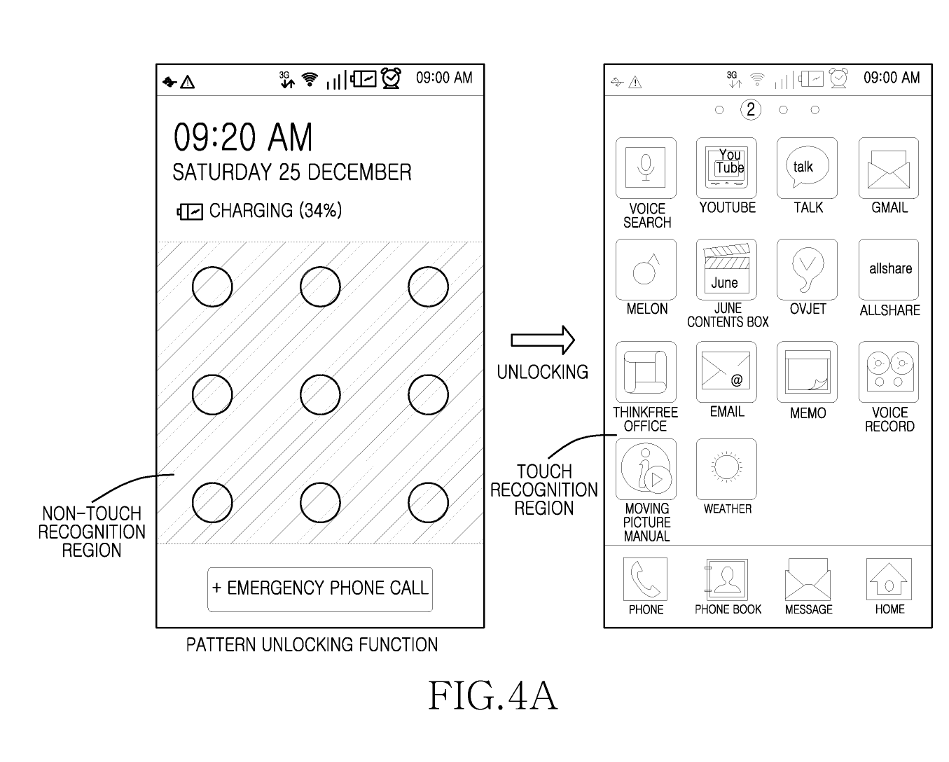

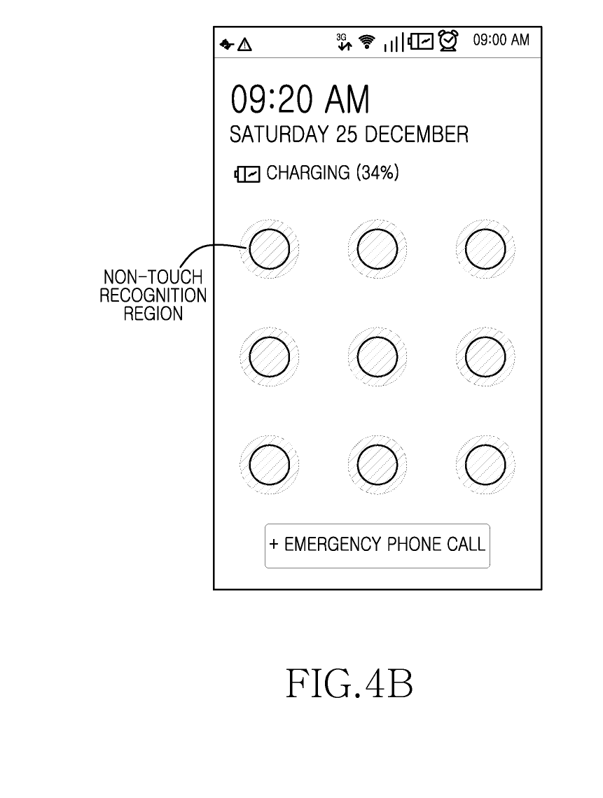

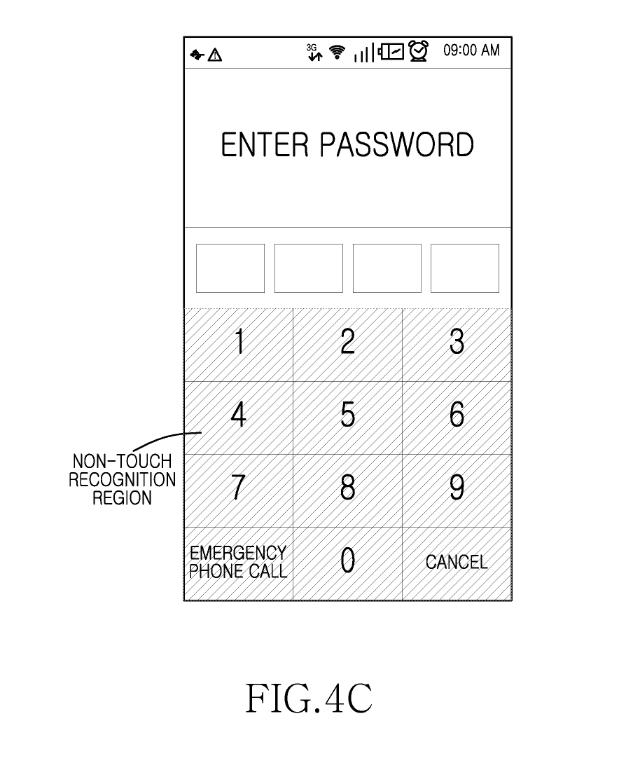

FIGS. 4A to FIG. 4C illustrate a screen for displaying a corresponding function performed by a non-contact touch sensing method in a capacitive touch screen terminal according to an exemplary embodiment of the present invention.

Referring now to FIG. 4A, a pattern locking/unlocking function is performed by the non-contact touch sensing method. The capacitive touch screen terminal sets a pattern, connected when a user touches and moves points selected among 9 points displayed thereon in order, to a password using the pattern locking function. If the user touches and moves the selected points by the predetermined pattern, the capacitive touch screen terminal unlocks the password using the pattern unlocking function.

For example, when the pattern unlocking function is executed, as shown in FIG. 4A, a deviant crease line portion of a screen is designated as a non-contact touch sensing region. In other words, the non-contact touch sensing region is a portion with a leakage risk of personal information. Accordingly, finger marks must not remain at the non-contact touch sensing region. The user may unlock the password without allowing a finger of the user to be in contact with the screen. If the password is unlocked, that is, when the pattern unlocking function is ended, as shown in FIG. 4A, a home picture is displayed and designated as a touch recognition region. Icons for executing a variety of functions are displayed on the home picture. If a corresponding icon is touched, the corresponding function is executed. If the executed corresponding function is set to be performed by the non-contact touch sensing method, the non-contact touch sensing region may be implemented according to the setting.

Referring now to FIG. 4B, as described above, the pattern locking/unlocking function is performed by the non-contact touch sensing method. In an exemplary embodiment of FIG. 4B which is different from that of FIG. 4A, if the pattern unlocking function is executed, only portions around 9 points are designated as non-contact sensing (recognition) regions.

Referring now to FIG. 4C, a password input function is performed by the non-contact touch sensing method. As shown in FIG. 4C, if a user enters four-digit numbers correctly at a number keypad using the password input function, the capacitive touch screen terminal unlocks the password. For example, if the password input function is executed, a portion where the number keypad is displayed on a screen is designated as a non-contact touch sensing region. That is, the number keypad. is a portion with leakage risk of personal information, and it is desired that fingerprints do not remain at the number keypad for security reasons. The user may unlock the password without allowing a finger of the user to be in contact with the screen. If the password is unlocked, the password input function is ended and the non-contact touch sensing region is also released.

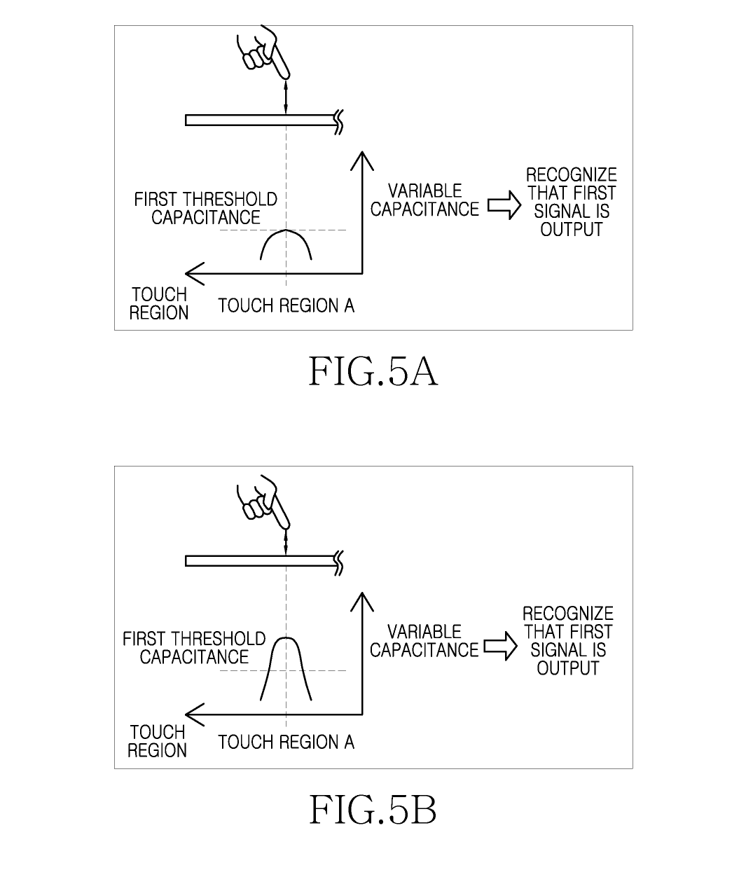

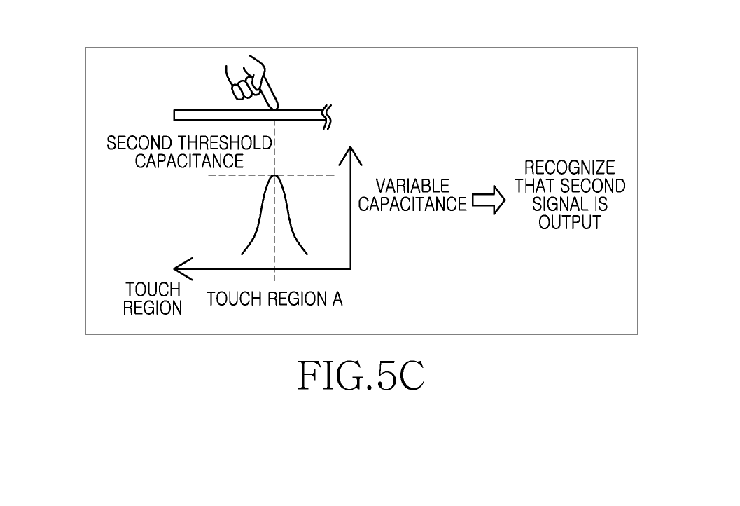

FIG. 5A illustrates a process of outputting a plurality of signals according to distance in which a conductor is adjacent to a corresponding touch region in a capacitive touch screen terminal according to an exemplary embodiment of the present invention.

Referring now to FIG. 5A, a corresponding touch region “A” according to an exemplary embodiment of the present invention is set to a first threshold capacitance and a second threshold capacitance. The capacitance of the corresponding touch region A changes according to an approach of a conductor. The controller 14 checks the (variable) capacitance of the corresponding touch region “A”. When the variable capacitance reaches the first threshold capacitance, the controller 14 recognizes that a first signal is output. When the variable capacitance reaches the second threshold capacitance, the controller 14 recognizes that a second signal is output. The variable capacitance reaches the first threshold capacitance first. That is, the first signal precedes the second signal. Comparing FIG. 5A to FIG. 5B, the distance of the finger from the touchscreen is shorter in FIG. 5B.

As shown in FIG. 5A, the controller 14 recognizes that the first signal is output by the non-contact touch sensing method. In FIG.5C, the controller 14 recognizes that the second signal is output by a touch recognition method. It is shown in FIG. 5C that the finger is touching the screen.

In FIG. 5A, if the available capacitance reaches the first threshold capacitance and the controller 14 recognizes that the first signal is output.

In FIG. 5B, if the available capacitance is between the first threshold capacitance and the second threshold capacitance, the controller 14 recognizes that the first signal is output.

In FIG. 5C, if the available capacitance reaches the second threshold capacitance, the controller 14 may recognize that all of the first and second signals are output because it may recognize that the first signal is output when the variable capacitance is greater than or equal to the first threshold capacitance. However, in order to differently perform an operation executed according to each signal, it is desirable to recognize that the first signal is changed to the second signal and the second is output. In addition, the controller 14 may recognize that any one of the first signal and the second signal which are continuously output is invalid if a threshold time passes.

If a user removes the conductor which is in contact with the screen, the controller 14 may recognize that the first signal is output until the variable capacitance returns to the first threshold capacitance. However, the controller 14 ignores the first signal.

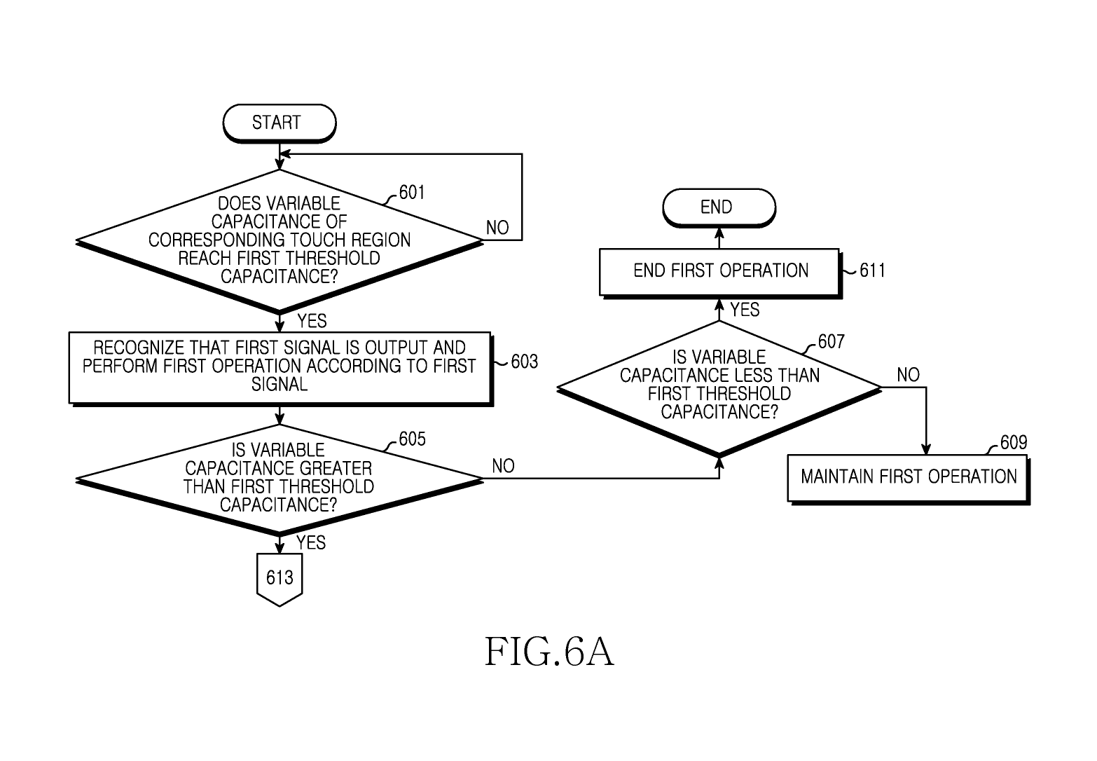

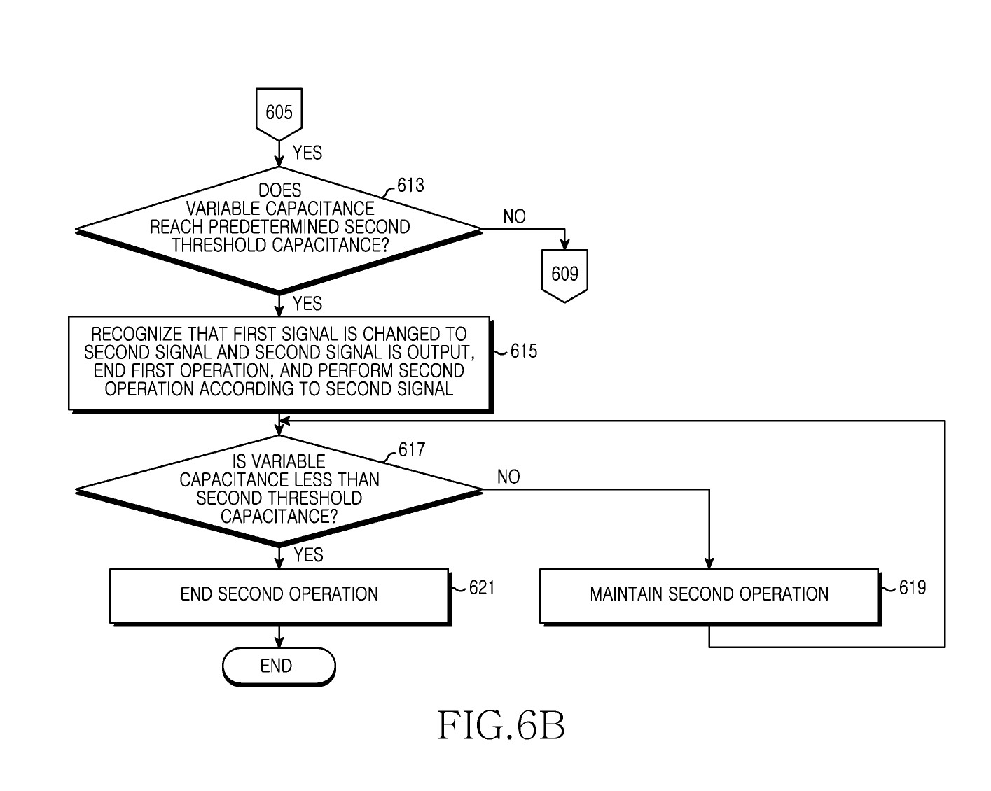

FIG. 6A is a flowchart illustrating a process of recognizing that a plurality of signals are output according to distance in which a conductor is adjacent to a corresponding touch region in a capacitive touch screen terminal according to an exemplary embodiment of the present invention.

FIG. 6B is a flowchart providing a loop that continues from and may go back to the process of FIG. 6A.

Referring now to FIGS. 6A and 6B, at step (601) the controller 14 verifies whether variable capacitance of a corresponding touch region reaches predetermined first threshold capacitance.

If the variable capacitance reaches the first threshold capacitance, then at step (603) controller 14 recognizes that the first signal is output and performs a first operation according to the first signal.

At step (605), the controller 14 verifies whether the variable capacitance is greater than the first threshold capacitance. If the variable capacitance is great than the first threshold capacitance, the controller 14 verifies whether the variable capacitance reaches predetermined second threshold capacitance (step 613 in FIG. 6B).

If the variable capacitance reaches the second threshold capacitance, at step (615) the controller 14 recognizes that the first signal is changed to a second signal and the second signal is output, ends the first operation, and performs a second operation according to the second signal.

If the variable capacitance is greater than the first threshold capacitance and does not reach the second threshold capacitance, then at step (609) the controller 14 maintains the first operation.

If the variable capacitance is not greater than the first threshold capacitance, that is, if the variable capacitance is less than or equal to the first threshold capacitance, then at step (607) the controller 14 verifies whether the variable capacitance is less than the first threshold capacitance. If the variable capacitance is less than the first threshold capacitance, then at step (611), the controller 14 ends the first operation. Also, if the variable capacitance is not less than the first threshold capacitance, that is, if the variable capacitance is equal to the first threshold capacitance, at step (609), the controller 14 maintains the first operation.

After the second operation is performed, at step (617) the controller 14 verifies whether the variable capacitance is less than the second threshold capacitance. If the variable capacitance is not less than the second threshold capacitance, that is, if the variable capacitance is greater than or equal to the second threshold capacitance, then at step (619) the controller 14 maintains the second operation. If the variable capacitance is less than the second threshold capacitance, then at step (621) the controller 14 ends the second operation.

As described above, because any one of the first signal and the second signal which are continuously output is invalid when a threshold time passes, the controller 14 may end any one of the first operation and the second operation. In order to output the first signal again, the controller 14 enables the variable capacitance to be less than the first threshold capacitance and reach the first threshold capacitance again. Also, in order to output the second signal again, the controller 14 enables the variable capacitance to be less than the first threshold capacitance and reach the second threshold capacitance again. The first signal precedes the second signal. If the variable capacitance reaches the second threshold capacitance, the first signal is changed to the second signal.

There are a variety of embodiments using the processes described in FIGS. 6A and 6B. For example, if a football game function is requested by a user, the controller 14 implements regions where a shooting button and a pass button are displayed as non-contact touch sensing regions described in FIGS. 5A-5C. If a finger of the user is approached to the shooting button, the controller 15 outputs the first signal first and displays a shoot preliminary action, that is, an action in which a character is raising his/her foot, according to the first signal. When the shoot preliminary action is over a threshold time, that is, the first signal is maintained at threshold time or more, the controller 14 ends the shoot preliminary action. In this case, the controller 14 may display a shoot trick action in which the character is raising and lowering his/her foot. In order to display the shoot preliminary action again, if a finger of the user is distant from the shooting button, the controller 14 output the first signal again. Also, if the first signal is stopped within the threshold time, that is, if the finger of the user is distant from the shooting button, the controller 14 ends the shoot preliminary action, that is, displays the shoot trick action.

If the first signal is changed to the second signal and the second signal is output after the shoot preliminary action according to the first signal is displayed, that is, if the finger of the user is in contact with the shooting button, the controller 14 ends the shoot preliminary action and displays a shoot action according to the second signal.

Therefore, a variety of motions of characters at various sports games may be implemented by the non-contact touch sensing method which outputs a plurality of signals at a corresponding touch region.

In conclusion, an input method and apparatus in a capacitive touch screen terminal according to an exemplary embodiment of the present invention is efficient by implementing the non-contact touch sensing method according to a corresponding function. This non-contact touch sensing method not only prevents leakage of personal information but also maintains a clean screen because fingerprints of a user do not remain on the screen. Also, the non-contact touch sensing method according to an exemplary embodiment of the present invention has high utilization by outputting a variety of signals at a corresponding touch region.

The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

It should be understood that the present invention is applicable to virtually any type of device in addition to a mobile terminal, regardless of their wireless transmission capability. While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An input method in a capacitive touch screen terminal, the input method comprising:
detecting by a controller whether a request of a corresponding function is made;
verifying by the controller whether or not the requested corresponding function is to be executed by a non-contact touch sensing method on a touch screen; and
configuring a display of a non-contact touch sensing region of the touch screen set for executing the corresponding function in which the corresponding function is to be executed by performing the non-contact touch sensing method by the controller sensing a specific pattern of a finger or pointer approaching a surface of the non-contact touch sensing region of the touch screen so as to trigger at least one threshold sensed by a sensor.

2. The input method of claim 1, further comprising releasing the configured non-contact touch sensing region of the touch screen when the controller determines that the corresponding function is ended.

3. The input method of claim 1, wherein the configuring of the non-contact touch sensing region of the touch screen comprises setting a threshold capacitance of the non-contact touch sensing region to be relatively lower than that of a contact touch sensing region.

4. The input method of claim 1, wherein the function performed by the non-contact touch sensing method comprises at least one of a password input function, a cipher function, and a multimedia function.

5. An input method in a capacitive touch screen terminal, the input method comprising:
verifying by a controller a variable capacitance of a corresponding touch region of the touch screen terminal; and
recognizing a first signal is being output when the variable capacitance reaches a first threshold level of capacitance and recognizing that a second signal is being output when the variable capacitance reaches a second threshold level capacitance which is higher than the first threshold level of capacitance.

6. The input method of claim 5, further comprising
recognizing that the first signal is being output when the variable capacitance is greater than the first threshold level capacitance and does not reach the second threshold level of capacitance.

7. The input method of claim 5, further comprising recognizing that the first signal is being changed to the second signal when the variable capacitance reaches the second threshold level of capacitance.

8. The input method of claim 5, further comprising recognizing that the second signal is not being output when the variable capacitance is less than the second threshold level capacitance after reaching the second threshold capacitance.

9. The input method of claim 6, further comprising ignoring the first signal until the variable capacitance reaches the first threshold level of capacitance after being at a level less than the second threshold level of capacitance subsequent to reaching the second threshold capacitance.

10. The input method of claim 5, wherein the first signal comprises a signal sensed by the touch screen according to the non-contact touch sensing method.

11. An input apparatus in a capacitive touch screen terminal, the input apparatus comprising:
a controller that is configured to verify whether or not a requested corresponding function is performed by a non-contact touch sensing method and configuring a non-contact touch sensing region of the touch screen to be set for the sensing performance of the corresponding function when the corresponding function is performed by the non-contact touch sensing method.

12. The input apparatus of claim 11, further comprising at least one sensor in the touch screen coupled to the controller to sense a specific pattern of a finger or fingers approaching a surface of the non-contact touch sensing region of the touch screen so as to trigger at least one change in a threshold capacitance level sensed by at least one sensor.

13. The input apparatus of claim 11, wherein the controller releases the configured non-contact touch sensing region of the touch screen when it is sensed that the corresponding function is ended.

14. The input method of claim 11, wherein the controller sets a threshold capacitance of the non-contact touch sensing region of the touch screen to be relatively lower than that of a contact touch sensing region of the touch screen.

15. The input method of claim 11, wherein the function performed by the non-contact touch sensing method comprises at least one of a password input function, a cipher function, and a multimedia function.

16. An input apparatus in a capacitive touch screen terminal, the input apparatus comprising a controller that recognizes a first signal is being output when a variable capacitance reaches a first threshold level of capacitance and recognizes that a second signal is being output when the variable capacitance reaches a second threshold level of capacitance which is higher than the first threshold level of capacitance.

17. The input apparatus of claim 16, wherein the controller determines the first signal is being output when the variable capacitance is greater than the first threshold level capacitance and does not reach the second threshold level of capacitance.

18. The input apparatus of claim 16, wherein the controller determines the first signal output is being changed to the second signal output when the variable capacitance reaches the second threshold level of capacitance.

19. The input apparatus of claim 16, wherein the controller determines the second signal is not being output when the variable capacitance is less than the second threshold level of capacitance subsequent to reaching the second threshold level of capacitance.

20. The input apparatus of claim 17, wherein the controller ignores the first signal until the variable capacitance reaches the first threshold level of capacitance after being less than the second threshold level of capacitance subsequent to reaching the second threshold level of capacitance.

21. The input apparatus of claim 16, wherein the first signal comprises a signal output according to a non-contact touch sensing method, further comprising at least one sensor in the touch screen coupled to the controller to sense a specific pattern of a finger or fingers approaching a surface of the non-contact touch sensing region of the touch screen terminal so as to trigger at least one change in a threshold capacitance level sensed by at least one sensor.
